(19) United States
(12) Patent Application Publication
(10) Pub. No.: US 2023/0099325 A1
(43) Pub. Date: Mar. 30, 2023

(54) INCIDENT MANAGEMENT SYSTEM FOR ENTERPRISE OPERATIONS AND A METHOD TO OPERATE THE SAME

(71) Applicant: ALGOMOX PRIVATE LIMITED, BENGALURU (IN)

(72) Inventors: ANIL ABRAHAM KURIAKOSE, BENGALURU (IN); ROSHNA RAJ THEKKEDATH MELETHIL, MALAPPURAM (IN)

(21) Appl. No.: 17/817,425

(22) Filed: Aug. 4, 2022

(30) Foreign Application Priority Data
Sep. 24, 2021 (IN) 202141043385

(51) Int. Cl. G06F 11/07; G06F 11/34

(52) U.S. Cl. CPC G06F 11/079; G06F 11/0769; G06F 11/3428

(57) ABSTRACT

An incident management system for enterprise operations is disclosed. The system 100 includes an operational details collection module 110, a data processing module 120, an operational details analysis module 130, an anomaly detection module 140 and an incident recognition module 150 including an incident cause analysis sub-module 155 and an incident cause description sub-module 160. The system 100 collects enterprise operational details from an operational database, analyzes huge volumes of logs, KPIs, traces, and IT asset relationships using proprietary machine learning techniques to identify one or more abnormal patterns, one or more hidden issues, one or more cross-domain performance issues, and one or more unusual system behaviors. Also, the system correlates, in real-time, with a huge volume of logs, KPIs, and IT system topologies to understand the relationship between different symptoms and problems at the machine's speed to arrive at a root cause and impacts. The system further understands the issues from a human recognition perspective using unique IT-specific natural language understanding techniques and generates a human-understandable text summary of the incident and root cause.

### CROSS-REFERENCE TO RELATED APPLICATION

This application claims priority from a patent application filed in India having Patent Application No. 202141043385, filed on Sep. 24, 2021, and titled “AN INCIDENT MANAGEMENT SYSTEM FOR ENTERPRISE OPERATIONS AND A METHOD TO OPERATE THE SAME”.

### BACKGROUND

Embodiments of the present disclosure relate to a system for monitoring an information technology (IT) environment of an organization and more particularly to an incident management system for enterprise operations and a method to operate the same.

Evolution of enterprise technologies introduced a lot of complexities across IT operations. As and when the organizations adopt new technologies for the IT operations, operational complexity increases multi-fold. Current tools and monitoring methodologies does not fit here because the new and evolved system generates a massive volume of unstructured operational data. As a result, the IT operations team find it difficult to identify actual issues and incidents from several noise events coming out of the systems. In addition, they often miss unknown issues and hidden problems due to humans' inability or lack of capabilities of current tools to correlate data originated from different IT components. Therefore, the IT operations team becomes clueless about the IT system conditions due to inferior monitoring or visibility due to its evolved complexity. Also, they are regularly firefighting to find the root cause of different unknown issues. Various systems are available are adopted by the organizations to manage one or more incidents associated with the IT operations.

Conventionally, the system available for managing the one or more incidents includes analysing health of the system or applications in the IT environment by monitoring either key performance indicator (KPI) metrics or logs. However, such conventional system monitors only the KPIs which they are familiar with, and which have a good correlation with the system performance known in general. Manual selection of KPIs often may be biased towards frequently used KPIs which may miss identifying any unknown issues in the system. Moreover, such a conventional system analyses the logs of configured items (CIs) manually to identify what went wrong during the occurrence of an incident. Such manual analysis of the logs are limited and time-consuming activity.

Hence, there is a need for an improved incident management system for enterprise operations and a method to operate the same in order to address the aforementioned issues.

### BRIEF DESCRIPTION

In accordance with an embodiment of the present disclosure, an incident management system for enterprise operations is disclosed. The system includes a processing subsystem hosted on a server. The processing subsystem is configured to execute on a network to control bidirectional communications among a plurality of modules. The processing subsystem includes an operational details collection module configured to collect enterprise operational details associated with one or more enterprise services from an operational database, end devices or IT systems. The processing subsystem also includes a data processing module configured to pre-process the enterprise operational details collected from the operational database using one or more data pre-processing techniques. The processing subsystem also includes an operational details analysis module configured to identify one or more log messages and one or more key performance indicator metrics corresponding to the enterprise operational details within a predefined incident time window upon pre-processing of the enterprise operational details. The operational details analysis module is also configured to process each of the one or more log messages and the one or more key performance indicator metrics identified by using a corresponding log message parsing technique and a metrics processing technique respectively. The operational details analysis module is also configured to analyze each of the one or more log messages and the one or more key performance indicator metrics using a log analysis technique and a multivariate metric analysis technique respectively upon processing. The processing subsystem also includes an anomaly detection module configured to detect one or more anomalies within one or more analysed log messages and one or more analysed key performance indicator metrics using a corresponding point process anomaly detection technique and a multivariate metric anomaly detection technique respectively by utilizing a trained neural network models. The anomaly detection module is also configured to obtain one or more log clusters and one or more key performance indicator metrics clusters based on detection of the one or more anomalies within the one or more analysed log messages and the one or more analysed key performance indicator metrics respectively. The processing subsystem also includes an incident recognition module which includes an incident cause analysis sub-module configured to generate a weighted network graph by combining each of the one or more log clusters and the one or more key performance indicator metrics clusters obtained. The incident cause analysis sub-module is configured to generate a weighted network graph by combining each of the one or more log clusters and the one or more key performance indicator metrics clusters obtained. The incident cause analysis sub-module is also configured to recognise one or more incidents within a predefined incident window based on a co-occurrence weight score computed from the weighted network graph. The incident cause analysis sub-module is also configured to analyse a root cause associated with the one or more incidents recognised within the predefined incident window by identifying trigger of the enterprise operational details corresponding to the one or more incidents. The incident recognition module also includes an incident cause description sub-module configured to generate an incident description for user interpretation by utilizing an incident recognition summarization model based on an analysis of the root cause associated with the one or more incidents.

In accordance with another embodiment of the present disclosure, a method to operate the incident management system for enterprise operations is disclosed. The method includes collecting, by an operational details collection module of a processing subsystem, enterprise operational details associated with one or more enterprise services from an operational database, end devices or IT systems. The method also includes pre-processing, by a data processing module of the processing subsystem, the enterprise operational details collected from the operational database using one or more data pre-processing techniques. The method also includes identifying, by an operational details analysis module, one or more log messages and one or more key performance indicator metrics corresponding to the enterprise operational details within a predefined incident time window upon pre-processing of the enterprise operational details. The method also includes processing, by the operational details analysis module of the processing subsystem, each of the one or more log messages and the one or more key performance indicator metrics identified by using a corresponding log message parsing technique and a metrics processing technique respectively. The method also includes analyzing, by the operational details analysis of the processing subsystem, each of the one or more log messages and the one or more key performance indicator metrics using a log analysis technique and a multivariate metric analysis technique respectively upon processing. The method also includes detecting, by an anomaly detection module of the processing subsystem, one or more anomalies within one or more analysed log messages and one or more analysed key performance indicator metrics using a corresponding point process anomaly detection technique and a multivariate metric anomaly detection technique respectively by utilizing a trained neural network model. The method also includes obtaining, by the anomaly detection module of the processing subsystem, one or more log clusters and one or more key performance indicator metrics clusters based on detection of the one or more anomalies within the one or more analysed log messages and the one or more analysed key performance indicator metrics respectively. The method also includes generating, by an incident cause analysis sub-module of an incident recognition module of the processing subsystem, a weighted network graph by combining each of the one or more log clusters and the one or more key performance indicator metrics clusters obtained. The method also includes recognising, by the incident cause analysis sub-module of the incident recognition module of the processing subsystem, one or more incidents within a predefined incident window based on a co-occurrence weight score computed from the weighted network graph. The method also includes analysing, by the incident cause analysis sub-module of the incident recognition module of the processing subsystem, a root cause associated with the one or more incidents recognised within the predefined incident window by identifying trigger of the enterprise operational details corresponding to the one or more incidents. The method also includes generating, by an incident cause description sub-module of the incident recognition module of the processing subsystem, an incident description for user interpretation by utilizing an incident recognition summarization model based on an analysis of the root cause associated with the one or more incidents.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of an incident management system for enterprise operations in accordance with an embodiment of the present disclosure;

FIG. 2 is a schematic representation of an exemplary embodiment of an incident management system for enterprise operations of FIG. 1 in accordance with an embodiment of the present disclosure;

FIG. 3 is a block diagram of a computer or a server in accordance with an embodiment of the present disclosure; and

FIG. 4 (a) and FIG. 4 (b) is a flow chart representing the steps involved in a method of incident management system for enterprise operations in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method of an incident management system for enterprise operations. The system includes a processing subsystem hosted on a server. The processing subsystem is configured to execute on a network to control bidirectional communications among a plurality of modules. The processing subsystem includes an operational details collection module configured to collect enterprise operational details associated with one or more enterprise services from an operational database, end devices or IT systems. The processing subsystem also includes a data processing module configured to pre-process the enterprise operational details collected from the operational database using one or more data pre-processing techniques. The processing subsystem also includes an operational details analysis module configured to identify one or more log messages and one or more key performance indicator metrics corresponding to the enterprise operational details within a predefined incident time window upon pre-processing of the enterprise operational details. The operational details analysis module is also configured to process each of the one or more log messages and the one or more key performance indicator metrics identified by using a corresponding log message parsing technique and a metrics processing technique respectively. The operational details analysis module is also configured to analyze each of the one or more log messages and the one or more key performance indicator metrics using a log analysis technique and a multivariate metric analysis technique respectively upon processing. The processing subsystem also includes an anomaly detection module configured to detect one or more anomalies within one or more analysed log messages and one or more analysed key performance indicator metrics using a corresponding point process anomaly detection technique and a multivariate metric anomaly detection technique respectively by utilizing a trained neural network model. The anomaly detection module is also configured to obtain one or more log clusters and one or more key performance indicator metrics clusters based on detection of the one or more anomalies within the one or more analysed log messages and the one or more analysed key performance indicator metrics respectively. The processing subsystem also includes an incident recognition module which includes an incident cause analysis sub-module configured to generate a weighted network graph by combining each of the one or more log clusters and the one or more key performance indicator metrics clusters obtained. The incident cause analysis sub-module is also configured to recognise one or more incidents within a predefined incident window based on a co-occurrence weight score computed from the weighted network graph. The incident cause analysis sub-module is also configured to analyse a root cause associated with the one or more incidents recognised within the predefined incident window by identifying trigger of the enterprise operational details corresponding to the one or more incidents. The incident recognition module also includes an incident cause description sub-module configured to generate an incident description for user interpretation by utilizing an incident recognition summarization model.

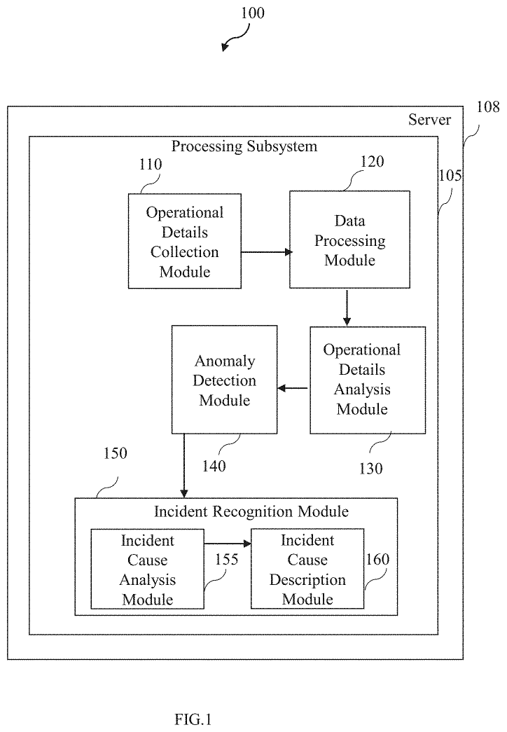

FIG. 1 is a block diagram of an incident management system 100 for enterprise operations in accordance with an embodiment of the present disclosure. The system 100 includes a processing subsystem 105 hosted on a server 108. In one embodiment, the server 108 may include a cloud server. In another embodiment, the server 108 may include a local server. The processing subsystem 105 is configured to execute on a network (not shown in FIG. 1) to control bidirectional communications among a plurality of modules. In one embodiment, the network may include a wired network such as local area network (LAN). In another embodiment, the network may include a wireless network such as Wi-Fi, Bluetooth, Zigbee, near field communication (NFC), infra-red communication (RFID) or the like.

The processing subsystem 105 includes an operational details collection module 110 configured to collect enterprise operational details associated with one or more enterprise services from an operational database end devices or IT systems. In one embodiment, the enterprise operational details may include at least one of details of a plurality of configured items (CIs), details of a plurality of sub-configured items (sub-Cis) or a combination thereof. In such embodiment, the details of the plurality of configured items comprises at least one of server, applications internet protocol address, database or a combination thereof. In some embodiment, the details of the plurality of sub-CIs may include, but not limited to, disk, central processing unit (CPU), memory, device, fstype, mountpoint and the like. In one embodiment, the one or more enterprise services may include at least one of electronic commerce web application service, logistics service, delivery service, payment gateway service or a combination thereof.

The processing subsystem 105 also includes a data processing module 120 configured to pre-process the enterprise operational details collected from the operational database using one or more data pre-processing techniques. In one embodiment, the one or more data pre-processing techniques may include at least one of missing value handling, data interpolation, data scaling or a combination thereof.

The processing subsystem 105 also includes an operational details analysis module 130 configured to identify one or more log messages and one or more key performance indicator (KPI) metrics corresponding to the enterprise operational details within a predefined incident time window upon pre-processing of the enterprise operational details. As used herein, the term ‘KPI’ is defined as a quantifiable measure of performance over time for a specific objective. Similarly, the term ‘one or more log messages’ is defined as a computer-generated data file that contains information about usage patterns, activities, and operations within an operating system, application, server or another device. In a specific embodiment, the operational details analysis module identifies gauge KPI metrics for anomaly detection. In such embodiment, the gauge metrics are mostly continuous values which vary within a specific range in normal scenarios.

The operational details analysis module 130 is also configured to process each of the one or more log messages and the one or more key performance indicator metrics identified by using a corresponding log message parsing technique and a metrics processing technique respectively. In one embodiment, the log message parsing technique includes identifying parameters of the one or more log messages through regex match and replacing one or more symbols and one or more numbers of the one or more log messages. In another embodiment, the metrics processing technique includes key performance indicator filtering technique and key performance indicator normalization. The KPI selection for dimension reduction functions is based on the concept of correlation clusters. The operational details analysis module clusters various metrics based on correlation between the metrics. Then, representatives with high variations are selected from each cluster so metrics with all patterns for analysis are available. Custom hyper-parameter tuning is done for finding optimal clusters.

The operational details analysis module 130 is also configured to analyze each of the one or more log messages and the one or more key performance indicator metrics using a log analysis technique and a multivariate metric analysis technique respectively upon processing. In one embodiment, the log analysis technique includes log pattern recognition for first level of log clustering using a DBSCAN clustering procedure and a second level of log clustering within one or more first level of log clusters using a hierarchical clustering procedure and log classification of one or more second level of log clusters into a plurality of log types. First level of clustering is done based on token lengths of each messages. A custom DBSCAN clustering using eps value 0.50 and MinPts 2 are used for clustering log messages based on token length. Second level of clustering within the DBSCAN based clusters are done using number of matching K-mers. As used herein, the term ‘K-mers’ in a string are all the unique substrings of length k. Two log messages which belong to one K-mer based cluster have maximum number of common K-mers. A Levenstein Distance based matrices for all the K-mers of log messages are obtained for clustering. Hierarchical Clustering is used for obtaining flat clusters defined by the given linkage matrix. After this two-level filter, finally clusters for log messages are obtained in which each cluster have log messages having similar templates. Finally log messages within the clusters are compared with each other to identify parameters and replace it with tokens.

In a particular embodiment, the plurality of log types may include a regular interval log category, a random interval log category, a failed log category and an unknown log category. In such embodiment, the regular interval log category includes those logs which occur in regular intervals and have seasonality in their sequential occurrence pattern. In another embodiment, the failed log category may include log cluster which contains messages with erroneous levels or erroneous keywords. In yet another embodiment, the random interval log category may include log messages which occur at random point of time without any specific pattern. In one embodiment, the unknown log category may include one or more logs without any identified log type.

The processing subsystem 105 also includes an anomaly detection module (140) configured to detect one or more anomalies within one or more analysed log messages and one or more analysed key performance indicator metrics using a corresponding point process anomaly detection technique and a multivariate metric anomaly detection technique respectively by utilizing a trained neural network model. In one embodiment, the one or more anomalies may include at least one of one or more abnormal patterns, one or more hidden issues, one or more cross-domain performance issues, one or more unusual system behaviours or a combination thereof.

The anomaly detection module 140 is also configured to obtain one or more log clusters and one or more key performance indicator metrics clusters based on detection of the one or more anomalies within the one or more analysed log messages and the one or more analysed key performance indicator metrics respectively. In one embodiment, the one or more log clusters may include normal log clusters, rate anomaly log clusters and pattern anomaly log clusters. In another embodiment, the one or more key performance indicator metrics clusters may include normal key performance indicator clusters, warning key performance indicator clusters and anomaly key performance indicator clusters.

The processing subsystem 105 also includes an incident recognition module 150. The incident recognition module 150 also includes an incident cause analysis sub-module 155 configured to generate a weighted network graph by combining each of the one or more log clusters and the one or more key performance indicator metrics clusters obtained. As used herein, the term ‘weighted network graph’ is defined as a graph built by assigning weights for the co-occurrence of different KPI and log cluster values of various Cis of a business service. The incident cause analysis sub-module 155 is also configured to recognise one or more incidents within a predefined incident window based on a co-occurrence weight score computed from the weighted network graph. In one embodiment, the one or more incidents may include at least one of an availability condition, key performance indicator anomaly, log pattern, log anomaly, system stress condition, slap query condition, structured query language injection, brute force attack or a combination thereof.

The incident cause analysis sub-module 155 is also configured to analyse a root cause associated with the one or more incidents recognised within the predefined incident window by identifying trigger of the enterprise operational details corresponding to the one or more incidents. Once an incident is being recognized, next step is to identify the root cause of the incident. Now that the incident window is identified, use of the node-node pair weights is made to obtain the summary weight for each CI based on which all pairs has that particular CI. Again, those pairs consisting of anomalous cluster values for that CI are given penalty weights. Finally, CI which has the least summary weight is chosen as the root cause CI. The sole purpose of multiple layers of filtering to cluster the log message is to fasten the identification of root cause CI at this stage by reducing the number iterations and combination to check for identifying the root cause CI. The incident recognition module 150 also includes an incident cause description submodule 160 configured to generate an incident description for user interpretation by utilizing an incident recognition summarization model. The incident recognition summarization model performs intent classification using minimum corpus and less computational resources. For the intent classification, multi-layer perceptron neural network is used with Random Search hyperparameter tuning as it does not consume much memory and is very fast compared to other neural network architectures. Again, slot filling technique is applied for obtaining the context from the log message corresponding to the intent. Further, semantic frames are used for slot filling the summary with custom IT based entities. Therefore, the incident recognition summarization model takes less than 1 minute to process thousands of log messages and hundreds of metrics to identify incident and create summary for the root cause for multiple business services.

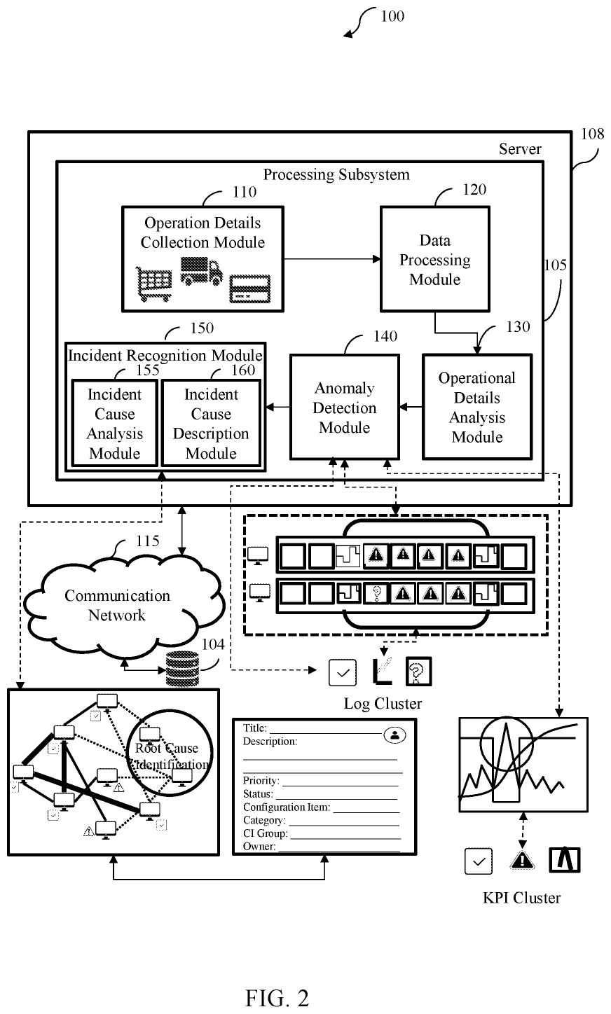

FIG. 2 is a schematic representation of an exemplary embodiment of an incident management system for enterprise operations of FIG. 1 in accordance with an embodiment of the present disclosure. Considering an example, wherein the system 100 is utilized in an organization for managing one or more enterprise services. In information technology management of the organization, there are numerous metrics for analysing health of the system or applications. It is extremely difficult to monitor all key performance indicators (KPIs) at the same time to identify what went wrong at the time of an incident. Similarly, analysing logs of configured items (CIs) to identify what went wrong during the occurrence of an incident is also a humungous job. The system 100 helps in analysing co-occurrence of one or more logs and one or more KPIs to identify the root cause of the one or more incidents.

For initiating analysis of the root cause of the one or more incidents, an operational details collection module 110 collects enterprise operational details associated with one or more enterprise services from an operational database 104, end devices or IT systems. The operational details collection module 110 is located on a processing subsystem 105 which is hosted on a cloud server 108. For example, the enterprise operational details for several types of enterprise services such as electronic commerce (e-commerce) services, logistics and delivery services and payment gateway services may include at least one of details of a plurality of configured items (CIs), details of a plurality of sub-configured items (sub-CIs) or a combination thereof. In such an example, the details of the plurality of configured items comprises at least one of server, applications internet protocol address, database or a combination thereof. In some example, the details of the plurality of sub-Cis may include, but not limited to, disk, central processing unit (CPU), memory, device, fstype, mountpoint and the like.

Once, the operational details are collected, a data processing module 120 pre-processes the enterprise operational details collected from the operational database using one or more data pre-processing techniques. For example, the one or more data pre-processing techniques may include at least one of missing value handling, data interpolation, data scaling or a combination thereof. Upon pre-processing of the enterprise operational details, an operational details analysis module 130 identifies one or more log messages and one or more key performance indicator (KPI) metrics corresponding to the enterprise operational details within a predefined incident time window. The operational details analysis module 130 also processes each of the one or more log messages and the one or more key performance indicator metrics identified by using a corresponding log message parsing technique and a metrics processing technique respectively. Here, the log message parsing technique includes identifying parameters of the one or more log messages through regex match and replacing one or more symbols and one or more numbers of the one or more log messages. Again, the metric processing technique includes key performance indicator filtering technique and key performance indicator normalization. The KPI selection for dimension reduction functions is based on the concept of correlation clusters. The operational details analysis module clusters various metrics based on correlation between the metrics. Then, representatives with high variations are selected from each cluster so metrics with all patterns for analysis are available.

Upon processing the one or more log messages and the one or more KPIs, the incident operational details analysis module 130 analyzes each of the one or more log messages and the one or more key performance indicator metrics using a log analysis technique and a multivariate metric analysis technique. In the example, used herein, the log analysis technique includes log pattern recognition for first level of log clustering using a DBSCAN clustering procedure and a second level of log clustering within one or more first level of log clusters using a hierarchical clustering procedure, Further, log classification of one or more second level of log clusters are done into a plurality of log types. For example, the plurality of log types may include a regular interval log category, a random interval log category, a failed log category and an unknown log category. In such an example, the regular interval log category includes those logs which occur in regular intervals and have seasonality in their sequential occurrence pattern. In another example, the failed log category may include log cluster which contains messages with erroneous levels or erroneous keywords. Again, the random interval log category may include log messages which occur at random point of time without any specific pattern. Further, the unknown log category may include one or more logs without any identified log type.

Based on analysis of the one or more log messages and the one or more KPI metrics, an anomaly detection module 140 detects one or more anomalies within one or more analysed log messages and one or more analysed key performance indicator metrics using a corresponding point process anomaly detection technique and a multivariate metric anomaly detection technique respectively by utilizing a trained neural network model. In the example used herein, the one or more anomalies may include at least one of one or more abnormal patterns, one or more hidden issues, one or more cross-domain performance issues, one or more unusual system behaviours or a combination thereof.

The anomaly detection module 140 also obtains one or more log clusters and one or more key performance indicator metrics clusters based on detection of the one or more anomalies within the one or more analysed log messages and the one or more analysed key performance indicator metrics respectively. For example, the one or more log clusters may include normal log clusters, rate anomaly log clusters and pattern anomaly log clusters. Again, the one or more key performance indicator metrics clusters may include normal key performance indicator clusters, warning key performance indicator clusters and anomaly key performance indicator clusters.

Further, an incident recognition module 150 includes an incident cause analysis sub-module 155 which generates a weighted network graph by combining each of the one or more log clusters and the one or more key performance indicator metrics clusters obtained. The weighted network graph is generated by combining each of the one or more log clusters and the one or more key performance indicator metrics clusters obtained. The incident cause analysis sub-module 155 is also configured to recognise one or more incidents within a predefined incident window based on a co-occurrence weight score computed from the weighted network graph. For example, the one or more incidents may include at least one of an availability condition, key performance indicator anomaly, log pattern, log anomaly, system stress condition, slap query condition, structured query language injection, brute force attack or a combination thereof.

In addition, the incident cause analysis sub-module 155 is also configured to analyse a root cause associated with the one or more incidents recognised within the predefined incident window by identifying trigger of the enterprise operational details corresponding to the one or more incidents. Once an incident is being recognized, next step is to identify the root cause of the incident. Now that the incident window is identified, use of the node-node pair weights is made to obtain the summary weight for each CI based on which all pairs has that particular CI. Again, those pairs consisting of anomalous cluster values for that CI are given penalty weights. Finally. CI which has the least summary weight is chosen as the root cause CI.

The incident recognition module 150 also includes an incident cause description sub-module 160 configured to generate an incident description for user interpretation by utilizing an incident recognition summarization model. The incident recognition summarization model performs intent classification using minimum corpus and less computational resources. For the intent classification, multi-layer perceptron neural network is used with Random Search hyperparameter tuning as it does not consume much memory and is very fast compared to other neural network architectures. Again, slot filling technique is applied for obtaining the context from the log message corresponding to the intent. Further, semantic frames are used for slot filling the summary with custom IT based entities. Therefore, the incident recognition module 150 understands the issues from a human recognition perspective using unique IT-specific natural language understanding techniques and generates a human-understandable text summary of the incident and root cause of the one or more incidents associated with the enterprise operations.

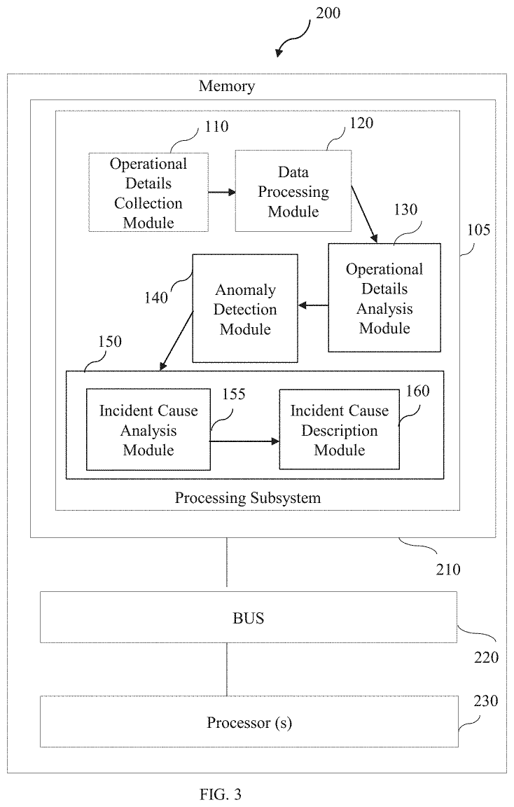

FIG. 3 is a block diagram of a computer or a server in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 includes a processing subsystem 105 of FIG. 1. The processing subsystem 105 further has following modules, an operational details collection module 110, a data processing module 120, an operational details analysis module 130, an anomaly detection module 140 and an incident recognition module 150, an incident cause analysis sub-module 155 and an incident cause description sub-module 160.

The operational details collection module 110 is configured to collect enterprise operational details associated with one or more enterprise services from an operational database, end devices or IT systems. The data processing module 120 is configured to pre-process the enterprise operational details collected from the operational database using one or more data pre-processing techniques. The operational details analysis module 130 is configured to identify one or more log messages and one or more key performance indicator metrics corresponding to the enterprise operational details within a predefined incident time window upon pre-processing of the enterprise operational details. The operational details analysis module 130 is also configured to process each of the one or more log messages and the one or more key performance indicator metrics identified by using a corresponding log message parsing technique and a metrics processing technique respectively. The operational details analysis module 130 is also configured to analyze each of the one or more log messages and the one or more key performance indicator metrics using a log analysis technique and a multivariate metric analysis technique respectively upon processing.

The anomaly detection module 140 is configured to detect one or more anomalies within one or more analysed log messages and one or more analysed key performance indicator metrics using a corresponding point process anomaly detection technique and a multivariate metric anomaly detection technique respectively by utilizing a trained neural network model. The anomaly detection module 140 is also configured to obtain one or more log clusters and one or more key performance indicator metrics clusters based on detection of the one or more anomalies within the one or more analysed log messages and the one or more analysed key performance indicator metrics respectively. The incident recognition module 150 includes an incident cause analysis submodule 155 which is configured to generate a weighted network graph by combining each of the one or more log clusters and the one or more key performance indicator metrics clusters obtained. The incident cause analysis submodule 155 is also configured to recognise one or more incidents within a predefined incident window based on a co-occurrence weight score computed from the weighted network graph. The incident cause analysis submodule 155 is also configured to analyse a root cause associated with the one or more incidents recognised within the predefined incident window by identifying trigger of the enterprise operational details corresponding to the one or more incidents. The incident recognition module 150 also includes an incident cause description sub-module 160 which is also configured to generate an incident description for user interpretation by utilizing an incident recognition summarization model.

The bus 220 as used herein refers to be internal memory channels or computer network that is used to connect computer components and transfer data between them. The bus 220 includes a serial bus or a parallel bus, wherein the serial bus transmits data in bit-serial format and the parallel bus transmits data across multiple wires. The bus 220 as used herein, may include but not limited to, a system bus, an internal bus, an external bus, an expansion bus, a frontside bus, a backside bus and the like.

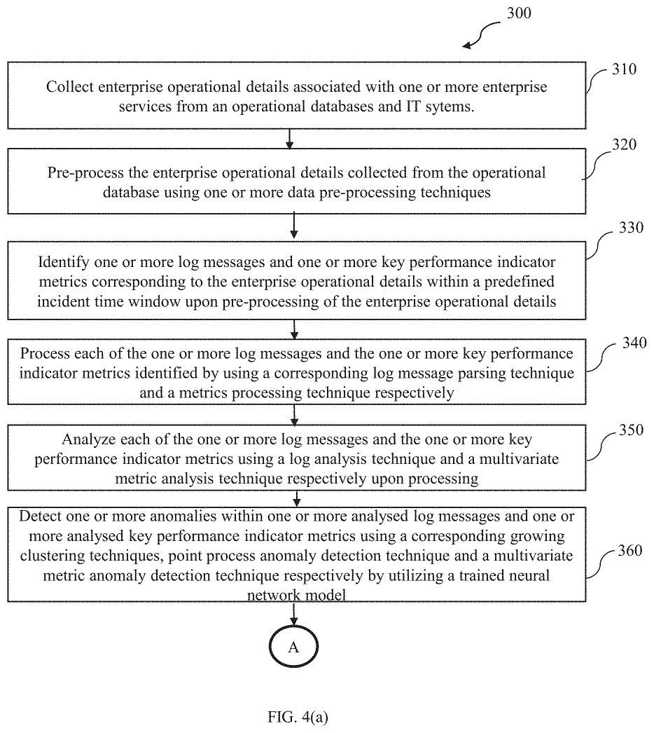

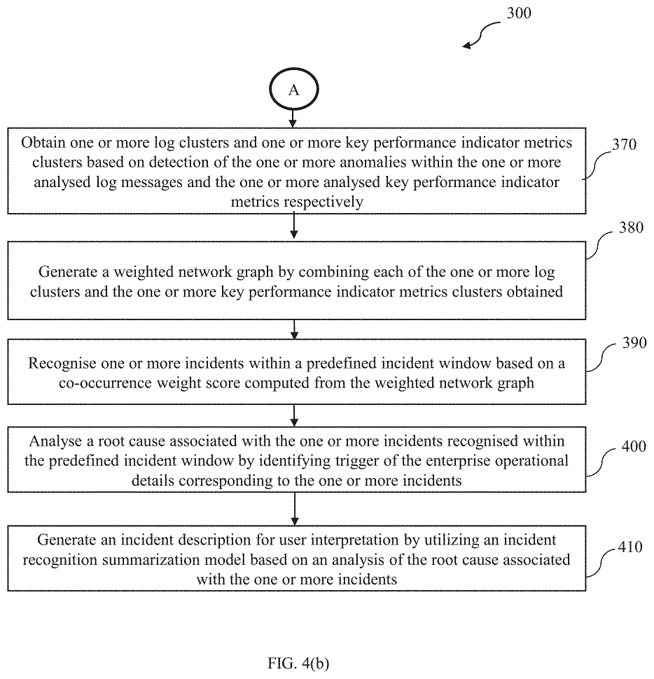

FIG. 4 (a) and FIG. 4 (b) is a flow chart representing the steps involved in a method 300 of incident management system for enterprise operations in accordance with an embodiment of the present disclosure. The method 300 includes collecting, by an operational details collection module of a processing subsystem, enterprise operational details associated with one or more enterprise services from an operational database, end devices or IT systems in step 310. In one embodiment, collecting the enterprise operational details associated with the one or more enterprise services may include collecting the enterprise operational details including at least one of details of a plurality of configured items (CIs), details of a plurality of sub-configured items (sub-Cis) or a combination thereof. In such embodiment, the details of the plurality of configured items comprises at least one of server, applications internet protocol address, database or a combination thereof. In some embodiment, the details of the plurality of sub-CIs may include, but not limited to, disk, central processing unit (CPU), memory, device, fstype, mountpoint and the like.

The method 300 also includes pre-processing, by a data processing module of the processing subsystem, the enterprise operational details collected from the operational database using one or more data pre-processing techniques in step 320. In one embodiment, pre-processing the enterprise operational details may include pre-processing the enterprise operational details including at least one of missing value handling, data interpolation, data scaling or a combination thereof.

The method 300 also includes identifying, by an operational details analysis module, one or more log messages and one or more key performance indicator metrics corresponding to the enterprise operational details within a predefined incident time window upon pre-processing of the enterprise operational details in step 330. The method 300 also includes processing, by the operational details analysis module of the processing subsystem, each of the one or more log messages and the one or more key performance indicator metrics identified by using a corresponding log message parsing technique and a metrics processing technique respectively in step 340. In one embodiment, processing each of the one or more log messages may include identifying parameters of the one or more log messages through regex match and replacing one or more symbols and one or more numbers of the one or more log messages. In another embodiment, processing the KPI metrics using the metrics processing technique may include key performance indicator filtering technique and key performance indicator normalization.

The method 300 also includes analyzing, by the operational details analysis module of the processing subsystem, each of the one or more log messages and the one or more key performance indicator metrics using a log analysis technique and a multivariate metric analysis technique respectively upon processing in step 350. In one embodiment, analysing each of the one or more log messages using the log analysis technique may include log pattern recognition for first level of log clustering using a DBSCAN clustering procedure and a second level of log clustering within one or more first level of log clusters using a hierarchical clustering procedure and log classification of one or more second level of log clusters into a plurality of log types. In such embodiment, the plurality of log types may include a regular interval log category, a random interval log category, a failed log category and an unknown log category.

The method 300 also includes detecting, by an anomaly detection module of the processing subsystem, one or more anomalies within one or more analysed log messages and one or more analysed key performance indicator metrics using a corresponding point process anomaly detection technique and a multivariate metric anomaly detection technique respectively by utilizing a trained neural network model in step 360. In some embodiment, detecting the one or more anomalies within the one or more analysed log messages and the one or more analysed key performance indicator metrics may include detecting at least one of one or more abnormal patterns, one or more hidden issues, one or more cross-domain performance issues, one or more unusual system behaviours or a combination thereof.

The method 300 also includes obtaining, by the anomaly detection module of the processing subsystem, one or more log clusters and one or more key performance indicator (KPI) metrics clusters based on detection of the one or more anomalies within the one or more analysed log messages and the one or more analysed key performance indicator metrics respectively in step 370. In one embodiment, obtaining the one or more log clusters and the one or more KPI metrics may include obtaining normal log clusters, rate anomaly log clusters and pattern anomaly log clusters. In another embodiment, the one or more key performance indicator metrics clusters may include normal key performance indicator clusters, warning key performance indicator clusters and anomaly key performance indicator clusters.

The method 300 also includes generating, by an incident cause analysis sub-module of an incident recognition module of the processing subsystem, a weighted network graph by combining each of the one or more log clusters and the one or more key performance indicator metrics clusters obtained step 380. The method 300 also includes recognising, by the incident cause analysis sub-module of the incident recognition module of the processing subsystem, one or more incidents within a predefined incident window based on a co-occurrence weight score computed from the weighted network graph in step 390. In one embodiment, recognising the one or more incidents within the predefined incident window may include recognising at least one of an availability condition, key performance indicator anomaly, log pattern, log anomaly, system stress condition, slap query condition, structured query language injection, brute force attack or a combination thereof.

The method 300 also includes analysing, by the incident cause analysis sub-module of the incident recognition module of the processing subsystem, a root cause associated with the one or more incidents recognised within the predefined incident window by identifying trigger of the enterprise operational details corresponding to the one or more incidents in step 400. The method 300 also includes generating, by an incident cause description submodule of the incident recognition module of the processing subsystem, an incident description for user interpretation by utilizing an incident recognition summarization model based on an analysis of the root cause associated with the one or more incidents in step 410. In some embodiment, generating the incident description for the user interpretation may include generating the incident description by utilizing the incident recognition summarization model for intent classification, entity recognition and slot filling using semantic frames.

Various embodiments of the present disclosure of automated observability techniques and incident extraction techniques to recognize incidents, automated root cause analysis, and automated incident summary generation.

Moreover, the present disclosed system analyzes huge volumes of logs, KPIs, traces, and IT asset relationships using proprietary machine learning techniques to identify abnormal patterns, hidden issues, cross-domain performance issues, and unusual system behaviors. Also, it correlates, in real-time, with a huge volume of logs, KPIs, and IT system topologies to understand the relationship between different symptoms and problems at the machine's speed to arrive at a root cause and impacts.

Furthermore, the present disclosed system understands the issues from a human recognition perspective using unique IT-specific natural language understanding techniques and generates a human-understandable text summary of the incident and root cause.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples

We claim:

1. An incident management system for enterprise operations comprising:
a processing subsystem hosted on a server, wherein the processing subsystem is configured to execute on a network to control bidirectional communications among a plurality of modules comprising:
an operational details collection module configured to collect enterprise operational details associated with one or more enterprise services from an operational database, one or more end devices or information technology systems;
a data processing module operatively coupled to the operational details collection module, wherein the data processing module is configured to pre-process the enterprise operational details collected from the operational database using one or more data pre-processing techniques;
an operational details analysis module operatively coupled to the data processing module, wherein the operational details analysis module is configured to:
identify one or more log messages and one or more key performance indicator metrics corresponding to the enterprise operational details within a predefined incident time window upon pre-processing of the enterprise operational details;
process each of the one or more log messages and the one or more key performance indicator metrics identified by using a corresponding log message parsing technique and a metrics processing technique respectively; and
analyze each of the one or more log messages and the one or more key performance indicator metrics using a log analysis technique and a multivariate metric analysis technique respectively upon processing;
an anomaly detection module operatively coupled to the operational details analysis module, wherein the anomaly detection module is configured to:
detect one or more anomalies within one or more analysed log messages and one or more analysed key performance indicator metrics using a corresponding point process anomaly detection technique and a multivariate metric anomaly detection technique respectively by utilizing a trained neural network model; and
obtain one or more log clusters and one or more key performance indicator metrics clusters based on detection of the one or more anomalies within the one or more analysed log messages and the one or more analysed key performance indicator metrics respectively; and
an incident recognition module operatively coupled to the anomaly detection module, wherein the incident recognition module comprises:
an incident cause analysis sub-module configured to:
generate a weighted network graph by combining each of the one or more log clusters and the one or more key performance indicator metrics clusters obtained;
recognise one or more incidents within a predefined incident window based on a co-occurrence weight score computed from the weighted network graph; and
analyse a root cause associated with the one or more incidents recognised within the predefined incident window by identifying trigger of the enterprise operational details corresponding to the one or more incidents; and
an incident cause description sub-module configured to generate an incident description for user interpretation by utilizing an incident recognition summarization model based on an analysis of the root cause associated with the one or more incidents.

2. The system as claimed in claim 1, wherein the enterprise operational details comprises at least one of details of a plurality of configured items, details of a plurality of sub-configured items or a combination thereof.

3. The system as claimed in claim 2, wherein the details of the plurality of configured items comprises at least one of server, applications internet protocol address, database or a combination thereof.

4. The system as claimed in claim 1, wherein the one or more enterprise services comprising at least one of electronic commerce web application service, logistics service, delivery service, payment gateway service or a combination thereof.

5. The system as claimed in claim 1, wherein the one or more data pre-processing techniques comprises at least one of missing value handling, data interpolation, data scaling or a combination thereof.

6. The system as claimed in claim 1, wherein the log message parsing technique comprises identifying parameters of the one or more log messages through regex match and replacing one or more symbols and one or more numbers of the one or more log messages.

7. The system as claimed in claim 1, wherein the metrics processing technique comprises key performance indicator filtering technique and key performance indicator normalization.

8. The system as claimed in claim 1, wherein the log analysis technique comprises log pattern recognition for first level of log clustering using a DBSCAN clustering procedure and a second level of log clustering within one or more first level of log clusters using a hierarchical clustering procedure and log classification of one or more second level of log clusters into a plurality of log types.

9. The system as claimed in claim 7, wherein the plurality of log types comprises a regular interval log category, a random interval log category, a failed log category and an unknown log category.

10. The system as claimed in claim 1, wherein the one or more anomalies comprises at least one of one or more abnormal patterns, one or more hidden issues, one or more cross-domain performance issues, one or more unusual system behaviours or a combination thereof.

11. The system as claimed in claim 1, wherein the one or more log clusters comprises normal log clusters, rate anomaly log clusters and pattern anomaly log clusters.

12. The system as claimed in claim 1, wherein the one or more key performance indicator metrics clusters comprises normal key performance indicator clusters, warning key performance indicator clusters and anomaly key performance indicator clusters.

13. The system as claimed in claim 1, wherein the one or more incidents comprises at least one of an availability condition, key performance indicator anomaly, log pattern, log anomaly, system stress condition, slap query condition, structured query language injection, brute force attack or a combination thereof.

14. A method comprising:
collecting, by an operational details collection module of a processing subsystem, enterprise operational details associated with one or more enterprise services from an operational database, one or more end devices or information technology systems;
pre-processing, by a data processing module of the processing subsystem, the enterprise operational details collected from the operational database using one or more data pre-processing techniques;
identifying, by an operational details analysis module, one or more log messages and one or more key performance indicator metrics corresponding to the enterprise operational details within a predefined incident time window upon pre-processing of the enterprise operational details;
processing, by the operational details analysis module of the processing subsystem, each of the one or more log messages and the one or more key performance indicator metrics identified by using a corresponding log message parsing technique and a metrics processing technique respectively;
analyzing, by the operational details analysis module of the processing subsystem, each of the one or more log messages and the one or more key performance indicator metrics using a log analysis technique and a multivariate metric analysis technique respectively upon processing;
detecting, by an anomaly detection module of the processing subsystem, one or more anomalies within one or more analysed log messages and one or more analysed key performance indicator metrics using a corresponding point process anomaly detection technique and a multivariate metric anomaly detection technique respectively by utilizing a trained neural network model;
obtaining, by the anomaly detection module of the processing subsystem, one or more log clusters and one or more key performance indicator metrics clusters based on detection of the one or more anomalies within the one or more analysed log messages and the one or more analysed key performance indicator metrics respectively;
generating, by an incident cause analysis sub-module of an incident recognition module of the processing subsystem, a weighted network graph by combining each of the one or more log clusters and the one or more key performance indicator metrics clusters obtained;
recognising, by the incident cause analysis sub-module of the incident recognition module of the processing subsystem, one or more incidents within a predefined incident window based on a co-occurrence weight score computed from the weighted network graph;
analysing, by the incident cause analysis sub-module of the incident recognition module of the processing subsystem, a root cause associated with the one or more incidents recognised within the predefined incident window by identifying trigger of the enterprise operational details corresponding to the one or more incidents; and
generating, by an incident cause description sub-module of the incident recognition module of the processing subsystem, an incident description for user interpretation by utilizing an incident recognition summarization model based on an analysis of the root cause associated with the one or more incidents.
